(19) United States
(12) Patent Application Publication
(10) Pub. No.: US 2026/0099863 A1
(43) Pub. Date: Apr. 9, 2026

(54) SYSTEM AND METHOD FOR PROVIDING TARGETED VISUAL COMMUNICATIONS DISPLAY

(71) Applicant: K & R VENTURES, LLC., Toms River, NJ (US)

(72) Inventor: Yishayahu KRISPIN, Toms River, NJ (US)

(21) Appl. No.: 19/113,111

(22) PCT Filed: Sep. 19, 2022
(86) PCT No.: PCT/IB2022/058824

§ 371 Date: Mar. 19, 2025

(51) Int. Cl. G06Q 30/0251; G06V 10/94; G06V 20/17; G06V 20/52; G06V 20/56; H04N 7/18

(52) U.S. Cl. CPC G06Q 30/0261; G06V 10/95; G06V 20/17; G06V 20/53; G06V 20/56; H04N 7/185

(57) ABSTRACT

Systems and methods for automatically presenting information visually to third parties configured to display promotional offers to third parties. Information capturing systems capture live information around visual displays the captured information is processed to determine the number of people around the visual display, communicators communicate processed information and a server unit receive the processed information and generate promotional offers based on the number of people. The processing unit determines an optimum timing for presenting the promotional offers based on the determined number of people in the vicinity of the visual display and the visual display presents the promotional offers to the third parties at the optimum timing to increase effectiveness of the promotional offers.

### FIELD OF THE INVENTION

The present disclosure relates to a visual communication unit. In particular, the present disclosure relates to systems used to display location-based signals to third parties.

### BACKGROUND OF THE INVENTION

It is often useful to display information to subjects within one's surroundings. As visual displays are particularly good at displaying such information, visual displays may be carried by individuals as they move from location to location. The information may also be displayed to the individuals through roadside display boards, known as signages may be designed to persuade receivers of the merits of a given product or service.

The information being displayed by such wearable devices may be used to indicate, for example, safety information to other pedestrians of road users, such as alerting them that the wearer is slowing down, speeding up, turning right, turning left or the like. Further, these wearable devices may display location-based advertisements for the offers being offered at the nearby markets, theaters, malls, etc. These devices, worn by the sales agents, present current offers of one or more of nearby vendors to the local people in the market areas or roads.

However, for much of the time, the display may be blank or underused. Further, these platforms do not consider the relevant timing for advertisement based on the number of nearby people leading to the waste of advertisement resources. There is a need therefore to provide a system which may display pertinent and relevant information visually to the third parties. The invention described herein addresses the above-described needs.

### SUMMARY OF THE INVENTION

In one aspect of the invention, a system for automatically presenting information visually to third parties is disclosed. The system comprises a visual display configured to display promotional offers to the third parties and an information capturing system configured to capture live information in a vicinity area of the visual display. The system further comprises a processing unit configured to process the captured information and determine the number of people in the vicinity area of the visual display, a communicator configured to communicate the processed information and a server unit configured to receive the processed information through the communicator and generate promotional offers based on the determined number of people.

The system is characterized in that the processing unit determines an optimum timing for presenting the promotional offers on the visual display based on the determined number of people in the vicinity of the visual display, and the visual display presents the promotional offers to the third parties at the optimum timing to increase effectiveness of the promotional offers.

According to various examples, the visual display may be one or more of a wearable visual communications unit, an electronic display board, a digital screen installed in a vehicle, a digital shop display board or a public display device.

According to various examples, the visual display comprises is selected from at least one of a group consisting of: an array of light emitting diodes, a rear-facing display, a forward-facing display, an OLED display, turn signals, brake lights, and the like as well as combinations thereof.

As appropriate, the information capturing system comprises a radar-based system comprising an array of transmitters and receivers for transmitting electromagnetic waves towards a target region in the vicinity area and receiving the signals reflected from objects in the target area, respectively.

As appropriate, the information capturing system comprises a camera device configured to capture images in the vicinity of the visual display. The camera device is configured to capture still images, video images or a combination thereof.

As appropriate, the information capturing system comprises an unmanned aerial vehicle (UAV) configured to capture images in the vicinity of the visual display.

As appropriate, the information capturing system comprises a location tracker module configured to determine the number of automobiles on a road in the vicinity of the visual display in real time by communicating with a satellite navigation system.

As appropriate, the information capturing system comprises a location tracker module configured to communicate with an external navigation system to identify the number of active mobile phones in the vicinity of the visual display.

The information capturing system may be a part of the visual display or a separate unit from the visual display.

According to another aspect of the current invention, the processing unit is further configured to identify living beings and non-living beings in the vicinity area, identify human beings and non-human beings in the vicinity area and identify physical characteristics of the human beings in the vicinity area.

According to various examples, the physical characteristics of the human beings comprises one or more of gender, age, physique, clothing pattern, spectacles, shoes, hairstyles and carried items.

As appropriate, the system further comprises a memory unit for storing the information processed by the processing unit.

According to another aspect of the current invention, the server unit is further configured to receive live information from the information capturing system, process the captured information and determine the number of people in the vicinity area of the visual display and determine an optimum timing for presenting the promotional offers on the visual display based on the determined number of people in the vicinity of the visual display.

As appropriate, the server unit is a remote unit of an advertising company, a local shop or a business establishment.

As appropriate, the server unit is further configured to generate targeted offers based on the physical characteristics of the human beings in the vicinity area.

As appropriate, the visual display is further configured to provide a means for availing the promotional offers.

As appropriate, the means for availing the promotional offers comprises presenting on the visual display one or more of a coupon code, a bar code, a QR code.

In one aspect of the invention, a method for automatically presenting information visually to third parties is disclosed. The method comprises providing a visual display configured to display promotional offers to the third parties and capturing live information in a vicinity area of the visual display using an information capturing system. The method further comprises processing the captured information and determining the number of people in the vicinity area of the visual display and determining an optimum timing for presenting the promotional offers on the visual display based on the determined number of people in the vicinity of the visual display. The method also comprises generating promotional offers based on the determined number of people and presenting the promotional offers on the visual display at the optimum timing to increase effectiveness of the promotional offers.

As appropriate, the capturing live information comprises capturing through a radar-based system comprising an array of transmitters and receivers for transmitting electromagnetic waves towards a target region in the vicinity area and receiving the signals reflected from objects in the target area, respectively.

As appropriate, the capturing live information comprises capturing through a camera device configured to capture images in the vicinity of the visual display.

As appropriate, the capturing live information comprises capturing still images, video images or a combination thereof through the camera device.

As appropriate, the capturing live information comprises capturing through an unmanned aerial vehicle (UAV) configured to capture images in the vicinity of the visual display.

As appropriate, the capturing live information comprises capturing through a location tracker module configured to determine the number of automobiles on a road in the vicinity of the visual display in real time by communicating with a satellite navigation system.

As appropriate, wherein the capturing live information comprises capturing through a location tracker module configured to communicate with an external navigation system to identify the number of active mobile phones in the vicinity of the visual display.

According to another aspect of the current invention, processing the captured information further comprises identifying living beings and non-living beings in the vicinity area, identifying human beings and non-human beings in the vicinity area and identifying physical characteristics of the human beings in the vicinity area.

As appropriate, storing the processed information in a memory unit.

As appropriate, generating promotional offers further comprises generating targeted offers based on the physical characteristics of the human beings in the vicinity area.

As appropriate, providing a means for availing the promotional offers on the visual display.

### BRIEF DESCRIPTION OF THE DRAWINGS

For a better understanding of the embodiments and to show how it may be carried into effect, reference will now be made, purely by way of example, to the accompanying drawings.

With specific reference now to the drawings in detail, it is stressed that the particulars shown are by way of example and for purposes of illustrative discussion of selected embodiments only, and are presented in the cause of providing what is believed to be the most useful and readily understood description of the principles and conceptual aspects. In this regard, no attempt is made to show structural details in more detail than is necessary for a fundamental understanding; the description taken with the drawings making apparent to those skilled in the art how the several selected embodiments may be put into practice. In the accompanying drawings:

FIG. 1 illustrates a personal display system including a wearable display device designed for securing a rider of an open vehicle;

FIG. 2 illustrates a possible system architecture of various system components for providing automatic signaling for a user of a wearable display;

FIG. 3 is a flowchart illustrating a method for automatically presenting information visually to third parties;

FIG. 4A illustrates a signaling mechanism of the personal security platform;

FIG. 4B illustrates a grid of indicators arrangement of the signaling mechanism as illustrated in FIG. 6A as a grid constituting pixels, with a controller being configured to selectively activate only those indicators required to produce the required signal;

FIG. 5A schematically represents a delivery agent, wearing a delivery monitor, collecting a goods package from a first party and delivering the goods package to a second party;

FIG. 5B schematically represents a delivery monitoring system according to aspects of the current disclosure; and

FIG. 6A illustrates a possible system architecture of the personal security platform presenting the various system components and modules of the personal security platform;

FIG. 6B illustrates the activation mechanism of the personal security platform configured to provide automatic, manual and voice activation methods;

FIG. 7A illustrates a method used by the personal security platform to control at least one protecting agent such as a UAV as indicated in FIG. 1A;

FIG. 7B illustrates a method whereby the personal security platform is operable to monitor input of at least one platform component as indicated in FIG. 1A;

FIG. 8 illustrates a method used in the personal security platform for indicating a turn signal;

FIG. 9 illustrates a method used in the personal security platform for indicating a warning;

FIG. 10 illustrates a radar-based system to determine the number of people available in the vicinity of the advertisement display according to an aspect of the invention;

FIG. 11 illustrates a system employing an image capturing device installed on a wearable item to determine the number of people available in the vicinity of the advertisement display according to another aspect of the invention;

FIG. 12 illustrates a system employing an unmanned aerial vehicle (UAV) to capture images of a target region in the vicinity of the advertisement display;

FIG. 13 illustrates a system with crowd identification through navigation system of the automotives on a road; and

FIG. 14 illustrates a flowchart providing a method for presenting advertisements and promotional offers on a display.

### DETAILED DESCRIPTION OF EMBODIMENTS

The disclosure relates to systems and methods for a personal wearable mobile display unit which may provide location based visual presenation. For example a display may be used to present a location sensitive notification such as a hazzard warning, an advertisement, a signaling system operable to provide automatic signaling for a user of an open vehicle, local information and the like.

A wearable item such as a jacket, backpack, helment or the like, may include a command signal generating unit configured to generate at least one command signal for controlling at least one display unit such as a rear-facing display visible for an observer behind the user when wearing the wearable item. The rear-facing display may include one or more indicators and the rear-facing display is operable to receive at least one command signal thereby controlling each of the indicators according to command signal.

In various embodiments of the disclosure, one or more tasks as described herein may be performed by a data processor, such as a computing platform or distributed computing system for executing a plurality of instructions. Optionally, the data processor includes or accesses a volatile memory for storing instructions, data or the like. Additionally or alternatively, the data processor may access a non-volatile storage, for example, a magnetic hard-disk, flash-drive, removable media or the like, for storing instructions and/or data.

It is particularly noted that the systems and methods of the disclosure herein may not be limited in its application to the details of construction and the arrangement of the components or methods set forth in the description or illustrated in the drawings and examples. The systems and methods of the disclosure may be capable of other embodiments, or of being practiced and carried out in various ways and technologies.

Alternative methods and materials similar or equivalent to those described herein may be used in the practice or testing of embodiments of the disclosure. Nevertheless, particular methods and materials are described herein for illustrative purposes only. The materials, methods, and examples are not intended to be necessarily limiting.

### Description of the Embodiments

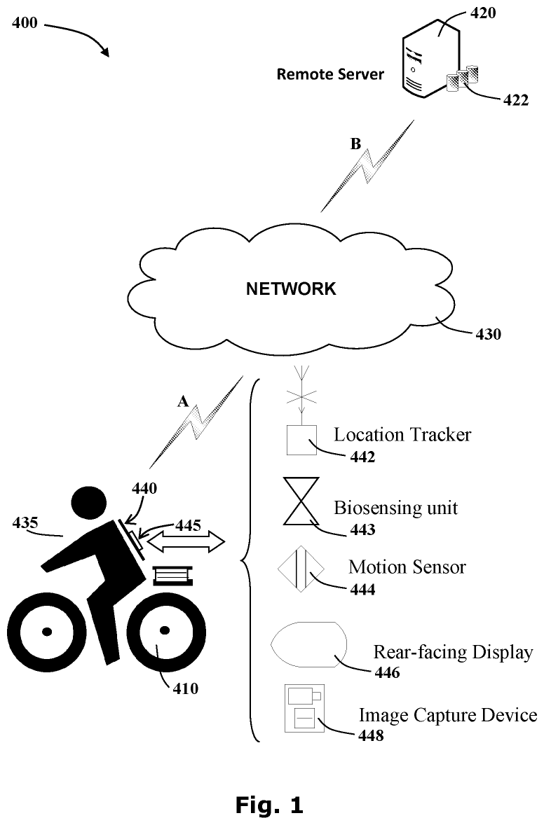

Reference is now made to FIG. 1, there is provided another personal display system, which is generally indicated at 400, including a wearable display worn by a rider of an open vehicle. The personal display system 400 comprises a wearable item 440 worn by a user 435 riding an open vehicle 410, the wearable item 440 comprising a command signal generating unit 445 operable to communicate with signaling agents and system components to provide automatic displays and further to communicate with a remote server 420 through network 430 and communication channel “A”.

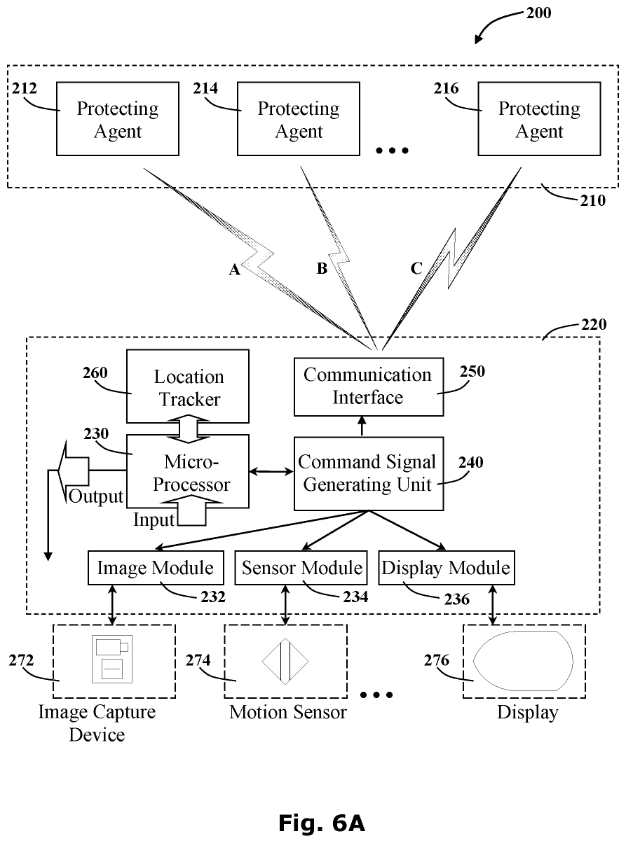

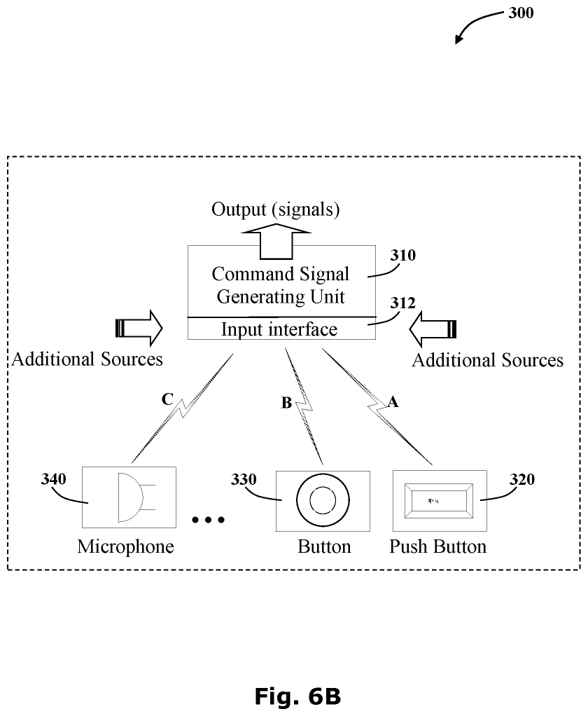

The wearable item 440 further comprises a display module comprising a rear-facing display 446 visible for an observer behind the user 435 when wearing the wearable item 442, where the rear-facing display 446 includes one or more indicators. The rear-facing display 446 is operable to receive at least one command signal from the command signal generating unit 445 thereby controlling each of the indicators (see FIG. 6A) according to signal commands.

Optionally, the display module comprises a front-facing display facing ahead towards the direction of motion and visible to observers ahead of the user 435.

The system 400 further comprises a location tracker module 442 for mapping and tracking a location. It is a particular feature of the invention that data from the location tracker module 442 is used by a microprocessor to determine a required visual presentation to be displayed on the display device of the wearable item.

The system 400 may further include a biosensing unit 443, a motion sensor module 444 for providing at least one motion parameter associated with the open vehicle 410 and an image capturing module 448 comprising at least one camera operable to provide at least one captured image, wherein the camera may be one or more of a front camera, a back camera and a side camera. All such units may further provide inputs to the microprocessor for determining a required visual presentation to be displayed.

It is noted that biosensing unit may comprise at least one biometric sensor such as selected from a group consisting of a pulse monitor; a breath monitor and the like as well as combinations thereof. For example a pulse sensor may be introduced near the wrist of a sleeve of the wearable item. Accordingly, in the event of accident, the display may be configured to display vital signs to emergency service providers attending the wearers.

Additionally or alternatively, the at least one personal protecting agent comprises at least one life support system. Optionally, the life support system comprises an air delivery system. Where appropriate, the at least one life support system may be configured and operable to actively heat the subject. Optionally, again, the at least one personal protecting agent may comprise a defibrillator which may be automatically triggered by a life support system when no pulse is detected.

Accordingly, a method is taught for protecting a subject via automatic security measures. The method may include providing a personal security platform, detecting an emergency event; and triggering at least one personal protecting agent. The method may further include monitoring biometric signals of the subject, delivering air to the subject, actively heating the subject, monitoring biometric signals of the subject, triggering a life support system and releasing a trace-color into the surrounding environment thereby rendering the subject visible to rescuers.

It is further noted that life support may be provided by tubing or air vents/air holes may be provided enabling the circulation of hot /arm air to keep the wearer warm. If he is under snow, this system may further be used to help to melt surrounding area to allow for air flow as well as to provide warmth.

Herein, the term “open vehicle” is used to denote a motorcycle, moped, motor scooter, manual or powered bicycle, or any other mode of transportation wherein a rider's upper body is exposed and readily visible to other travelers on the road.

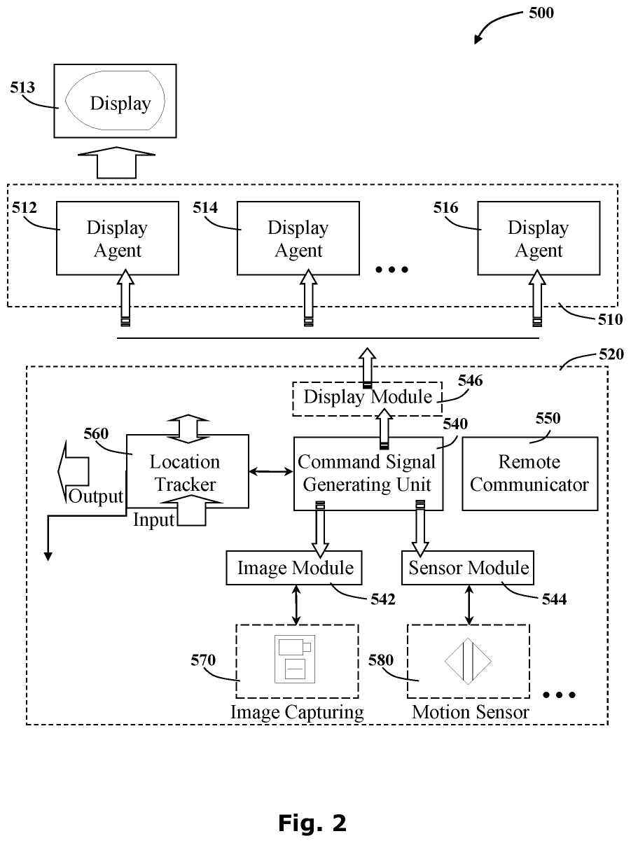

Reference is now made to FIG. 2, there is provided another possible system architecture of a personal security platform, which is generally indicated at 500, the architecture presents the various system components of the personal security platform for providing a signaling system operable to provide automatic signaling for a user of an open vehicle.

The personal security platform architecture 500 comprises a wearable item 520 operable to control at least one set 510 of signaling agents such as a first display agent 512, a second display agent 514 and a third display agent 516 in communication with a display 513.

It is noted that the display agents 512, 514 and 516 are presented as an example only and is intended to specify one or more protecting agents.

The wearable item 520 is configured to be worn by the user (FIG. 1, item 440) or attached to his garment, and comprises a command signal generating unit 540, a remote communicator unit 550, a location tracker 560, an image module 542 and a sensor module 544.

The command signal generating unit 540 is configured to generate at least one command signal for controlling at least one display agent. The command signal generating unit 540 may receive input from the location tracker 560, the communication unit 550 and various component modules. Based upon input from these units, the command signal generating unit 540 may select the required presentation to be displayed and the display module 546 may instruct the display agents accordingly.

The component modules associated with the platform, such as an image module 542 configured to manage an image capturing device 570, a sensor module 544 configured to manage at least one motion sensor 544, a display module 546 configured to manage a signaling agent of at least one display.

The remote communicator unit 550 may provide the communication channel to a remote server. Accordingly, the remote communicator unit 550 may receive instructions from the remote server to display, for example, location specific information in real time. Accordingly, a time and location sensitive advert may be displayed at the required time and place. By way of example, during a vaccine drive, a clinic may be able to notify nearby people that spare vaccines are available before they expire and are destroyed, similarly, restaurants or other food providers may be able to advertise for those nearby to receive items at reduced rates before they expire.

It is further noted that data collected by the image capturing device 570, location tracker 560 and sensor modules 544 may provide information pertaining to the actions and habits of the user. Accordingly, targeted messaging may be provided to the wearer themselves, either via an output of the wearable item 520 or via an external communication device such as a smartphone, or a wearable display worn by a third party within the vicinity.

For example, data may be gathered by sensors of the wearable device which indicate, for example, that the wearer tends to order a salad for lunch at a certain time. Such information may be combined with the position of the user and provided local eateries or salad bars in the vicinity of the user. Targeted messages may be sent to the user by local eateries offering salads possibly at discounted rates. Where multiple users are close to each other, such targeted messages may be sent directly to the user, for example, by displaying an advert on a third party wearable display directly within the eyeline of the user.

Additionally or alternatively, the consumer, may initiate the targeted messaging by logging in to a directory of local eateries to see if there are any local places that have their preferred options.

It will be appreciated that such targeted messaging may be manual or automatically managed for example using artificial intelligence or any other appropriate algorithm.

In still other embodiments, image capturing devices may be used to monitor delivery of a product, for example temperature of a pizza may be monitored upon delivery so as provide quality management feedback to the supplier. Still further data may be captured and utilized for improving transactions, such as capturing the transaction process to insure proper allocation of the orders.

It will be appreciated that the remote communicator unit 550 may further provide a communication channel to the remote server, for example to update a central manager with information of the movements of the wearer, or to alert emergency services in the even of an accident.

The display module 546 may control a display agent comprising a rear-facing display attached to the back of the user (FIG. 1, item 435) or a front-facing display attached to the user (FIG. 1, item 435) at the front or both.

The sensor module 544 is configured to determine at least one motion parameter associated with the user (FIG. 1, item 435) of the open vehicle (FIG. 1, item 410) and may be one or more of an accelerometer, a tilt sensor and a proximity sensor.

The image capturing module 542 is operable to control at least one camera that may be selected from a group of cameras consisting of a front camera, a back camera, a side camera and combinations thereof.

Accordingly, the command signal generating unit 540 is configured to generate at least one command signal to allow communication for controlling at least one signaling agent such as a display agent 512, a display agent 514 and a display agent.

The personal security platform architecture may further include a location tracker module 560 for tracking a location of the user, and the location tracker module 560 is configured to provide location based data to the command signal generating unit.

Optionally, the wearable item 520 comprises the location tracker module 560. Additionally, the wearable item 520 is configured to retrieve map data from an external source, based on data from the location tracking module 560. Optionally, the location tracker module 560 comprises a satellite navigation system. As appropriate, the location tracker module 560 is configured to communicate with an external satellite navigation system.

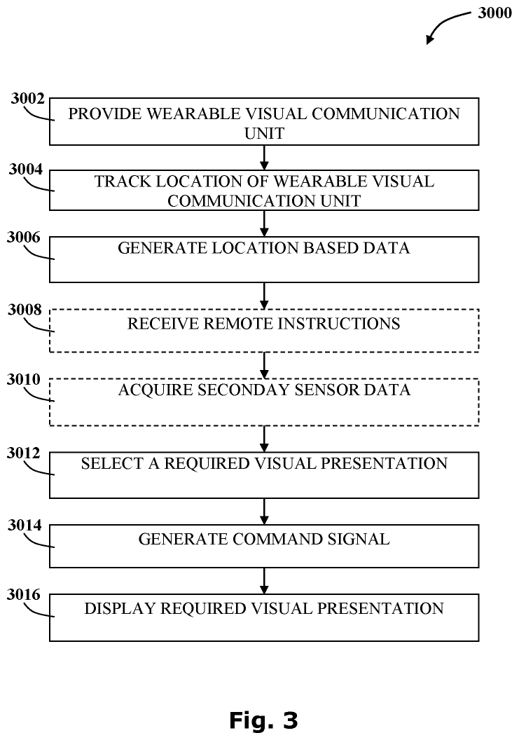

Reference is now made to the flowchart of FIG. 3 which represents a method 3000 for automatically presenting information visually to third parties. The method includes providing a wearable visual communications unit 3002, tracking the location of the wearable visual communication 3004, generating location-based data 3006, selecting a required visual presentation 3012, generating a command signal to control the visual display 3014 and presenting the required visual presentation on the display 3016.

Optionally, the remote communicator may receive remote instructions 3008. Similarly, the command signal generating unit may further acquire secondary sensor data 3010 such as from biometric sensors, movement sensors, and the like.

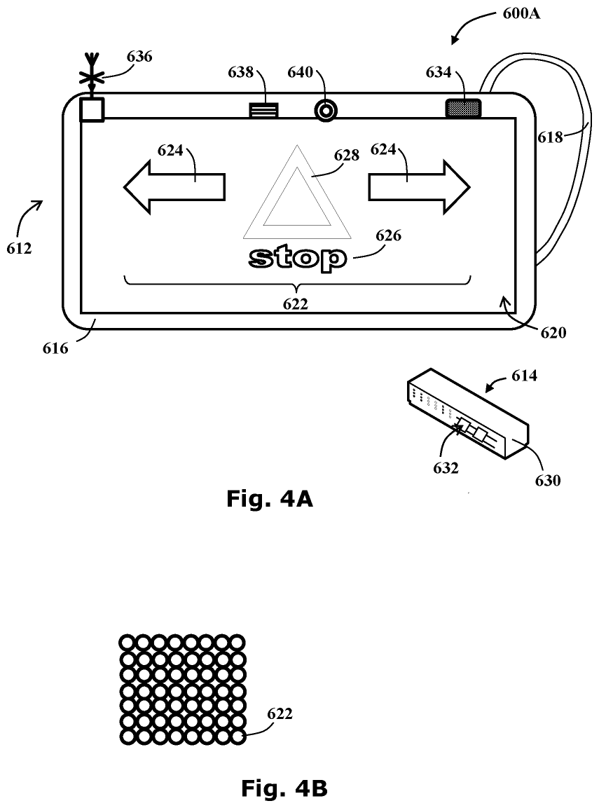

Reference is now made to FIG. 4A, there is provided a signaling mechanism of the personal security platform, which is generally indicated at 600A, designed for use by a rider of an open vehicle. Herein the specification and claims, the term “open vehicle” is used to denote a motorcycle, moped, motor scooter, manual, powered bicycle, skis, snowboard, sledge or any other mode of transportation wherein items worn by rider are exposed and readily visible to other surrounding viewers. The system 600 comprises a wearable item 612, a control interface 614, and a controller.

The wearable item 612 is configured to be worn by a user, and thus comprises a rear panel 616 and a carrying arrangement 618. The carrying arrangement 618 is configured to cooperate with the rear panel 616 to facilitate wearing the vest 612 such that when worn by a user, the rear panel 616 lays across the user's back, and is visible to an observer therebehind.

The carrying arrangement 618 may comprise a pair of straps, as illustrated. Alternatively, it may comprise any suitable arrangement to facilitate wearing the vest 612 as described above. According to one example, the carrying arrangement 18 may comprise a pair of front panels attached to bottom edges of the rear panel 616, giving rise to a pair of armholes. According to another example, the carrying arrangement 618 may comprise a single front panel attached to the rear panel 16 at two ends of a top edge thereof, giving rise to a neckhole, and being open at the sides.

The rear panel 616 comprises a rear-facing display 620 (i.e., disposed so as to be visible from an observer behind the user when wearing the vest 612), comprising one or more indicators, which are generally indicated at 622, thereon. The indicators 622 may be illuminative, for example comprising one or more light emitting diodes (LEDs). The controller is configured to operate the indicators 622 to produce signals signifying information about the user, in particular relating to parameters of the drive. According to some modifications, the display comprises a flexible screen, for example comprising organic light-emitting diodes (OLEDs), or any other suitable technology.

For example, one or more of the indicators 622 may be configured to signify that the user is about to or is in the middle of executing a right or left turn (i.e., constituting turn signals 624); one or more of the indicators 622 may be configured to signify that the user is in the middle of slowing down (i.e., constituting a brake light 626); one or more of the indicators 622 may be configured to signify a hazard such as a the vehicle being stopped in or near moving traffic, that the vehicle is disabled, that a vehicle is moving substantially slower than the flow of traffic, etc. (i.e., constituting a hazard warning light 628, which may be constantly illuminated or be flashing). It will be appreciated that the indicators 622 may be configured to display any other suitable message, mutatis mutandis.

According to some examples, as illustrated in FIG. 4B, the indicators 622 are arranged as a grid constituting pixels, with the controller being configured to selectively activate only those indicators required to produce the required signal. According to other examples, for example as illustrated in FIG. 6A, the indicators 622 comprise preformed signals, for example comprising LED strips, with the control being configured to selectively activate a required indicator to illuminate the required signal.

The control interface 614 is configured to facilitate the user to communicate with the vest 612, e.g., via the controller. It comprises a housing 630, which may contain the controller therein, and one or more user input devices 632. The user input devices 632 are configured to allow the user to indicate to the controller the type of signal to be displayed by the indicators 622 on the rear panel 616 of the vest. It may comprise, e.g., one or more switches, buttons, dials, etc., each of which (or positions of which) correspond to a different signal to be displayed by the indicators (e.g., turn signals, hazard warning lights, etc.).

According to some modifications, some or all of the user input devices 632 may be integrated into the vehicle, e.g., to be automatically activated during use of the vehicle. For example, for vehicles with integrated turn signals, user input devices 632 may be mounted to the vehicle such that when the user operates the vehicle turn signal, the user input device 632 is automatically operated. This may be accomplished mechanically (e.g., by positioning the user input device of the signaling system 600A such that movement of an element which operates the turn signal also operates the user input device), electrically (e.g., by wiring the user input device of the signaling system 600A to monitor an electrical signal which operates the turn signal of the vehicle, and to operate the indicators 622 accordingly), visually (i.e., by mounting cameras to monitor to turn signals of the vehicle, and operate the indicators 622 accordingly), or according to any other suitable method.

It will be appreciated that while the above example related to the turn signal of the vehicle, the user input device 632 may be similarly integrated to be automatically activated during use of the vehicle, mutatis mutandis. For example, a user input device may be situated so as to be activated by application of a brake pedal or grip, etc.

The control interface 614 is configured to communicate with the vest 612, e.g., the display 620 thereof, via any suitable method. According to some examples, they communicate wirelessly with each other, for example using one or more of a local area network, radio, Bluetooth, ZigBee, Near Field Communication, or any other suitable technology for facilitating wireless communication. A transmitter (not illustrated) may be integrated with the controller, and a receiver 634 provided on the vest 612 in communication with the display.

According to some modifications, the signaling system 600A does not comprises a dedicated control interface 614 and/or controller. Rather, the vest 612 (and elements thereof) is configured to communicate directly with a third-party device, such as a telephone (e.g., a mobile phone with advanced computing capabilities, herein “smartphone”) or any other suitable electronic device (such as a pocket-sized computer, for example as marketed under the trade name “iPod®” by Apple Inc.). The device may be configured (e.g., by installing an application thereon) to receive user input (e.g., by visually sensing hand motions, by presenting a simulated control interface, etc.) and communicate a command to the vest 612 to operate the indicators 622 accordingly.

According to some examples, the device may be an optical head-mounted display.

According to the above, the device constitutes both the control interface 614 and controller of the signaling system 600A.

The vest 612 may comprise a location tracker module 636, configured to determine the current location of the vest (and thus the user) in real time by communicating with the satellite navigation system (such as the Global Positioning System (GPS) satellite network or the like). According to some examples, the module may be provided with local street maps, for example via map data being loaded into a memory module thereof. According to other examples, the vest 612 may communicate location information determined by the satellite navigation system to a device (such as a smartphone, pocket-sized computer, etc.) which provides relevant map data thereto, e.g., based on the determined location. The signaling system 600A may provide this information to a remote party, e.g., to track the user. This may be useful for facilitating a business to track a fleet of delivery vehicles, for enabling a parent or guardian to locate a child, etc. An alarm 638, which may produce one or more of an audio and a visual signal, may be activated if a user goes beyond a predefined area.

It will be appreciated that while the vest 612 is described above as comprising a satellite navigation system module 636, the satellite navigation system module may be part of a separate unit configured to communicate therewith, including, but not limited to, a smartphone, a head-mounted display, a dedicated satellite navigation system module, the controller, etc., without departing from the scope of the presently disclosed subject matter.

Location tracking data may be used to compare the speed of the vehicle to the speed of surrounding traffic, for example based on internet-based real time traffic information. If the controller determines, based on the location tracking data and traffic information received, that the vehicle is moving at a speed which is significantly lower than that of surrounding traffic (e.g., a predetermined percentage or net speed amount lower), it may automatically activate the indicators 622 to display a hazard warning light 28. Similarly, location tracking data may be used to automatically detect if the vehicle is slowing down, wherein the controller may activate the indicators 622 to display a brake light 626.

The signaling system 600A may comprise one or more motion sensors (e.g., an accelerometer, tilt sensor, etc., not illustrated) configured to determine parameters of the motion of the vehicle. These parameters may include, but are not limited to, turning, braking, driving speed, etc. The signaling system 600A may thus be configured to automatically activate the indicators 622 to display a suitable signal.

For example, if the motion sensors determine that the vehicle is turning, it may automatically activate the indicators 622 to display a turn signal 624. This function may be integrated with location tracking data. Based on the determined location of the vehicle and corresponding map data, the signaling system 600A may be configured to determine whether a detected vehicle turn is a turn which should be indicated (for example turning onto a side street) or is a turn which should not be indicated (for example following the topography of a curved road). The signaling system 600A may thus be configured to activate appropriate indicators 622 based on both determinations made by the motion sensors and location tracking data. For example, the indicators may display a turn signal 624 when a vehicle turn is detected by the motion sensors, and the location tracking data suggests that a turn should be indicated. The controller may employ one or more heuristic algorithms to make the determination.

By using data from both motion sensors and location sensors, the signaling system 600A may be configured to automatically display a signal faster and/or more accurately than it would be able to be based only on one thereof. In addition to the example provided above with respect to a turn signal, the determination of vehicle speed (i.e., to automatically activate the indicators 622 to display a brake light 626 and/or hazard warning light 28, as described above) may be supplemented with data from the motion sensors.

The controller maybe configured, based on one or more of location tracking data and data from the motion sensors, to determine if an emergency (such as a collision) has occurred. It may further be configured to send out one or more appropriate distress signals, such as communicating with emergency services, sending a message to one or more predetermined contacts (such as a parent, etc.). The signaling system 600A may be configured to interface with a mobile telephone for this purpose.

The vest 612 may further comprise one or more cameras 640 on the rear panel 616, disposed so as to image the area behind the user when wearing the vest. Image data may be recorded and/or communicated to a display unit mounted on the vehicle in front of the user. The display unit may be a dedicated device, or a suitably-configured (e.g., by installation of an application thereon) smartphone and/or pocket-sized computer. The signaling system 600A may thus be used to provide a rear-view to a user when operating his vehicle. This data may be selectively communicated to one or more predetermined contacts of the user.

The signaling system may be configured to automatically archive, either locally or on a remote server accessed wirelessly, visual data recorded by the cameras 640. This may be done automatically, or be event-driven (i.e., in case of an accident).

In addition, the camera 640 may be configured to be used to enable the system 600A to detect and alert vehicles behind the user if they are approaching too closely or too quickly.

According to one example, image data captured by the camera 640 may be used by the controller to determine relative speed of a vehicle approaching from behind the user. This may be accomplished, e.g., by analyzing the image data to detect objects, determining an object to be an approaching vehicle, and tracking the relative size of the object compared to the size of the same object captured in previous frames. Thus, the system 600A may determine if a vehicle approaching from behind is accelerating or maintaining its speed when it should be slowing down, etc.

According to another example, image data captured by the camera 640 may be used by the controller to determine the distance of a vehicle behind the user. This may be accomplished, e.g., by analyzing the image data and comparing it to objects of known sizes. For example, the controller may be preloaded with information related to the size of one or more features of vehicles, such as the size of license plates, the distance between outer edges of headlights (which may be, e.g., typical distances for most cars, distances for particular models of cars which may be determined based on recognizing the front of the car, etc.), or any other suitable value. The controller may thus be configured to determine the distance by comparing the apparent size of the feature captured by the camera to the known size thereof.

The system 600A may be further configured to be used as a social media device. For example, it may be configured to share images captured by the camera 640 on one or more social media networks. It will be appreciated that the “sharing on a social media network” as used herein the specification and claims includes, but is not limited to, posting on an online social media platform such that it can be accessed by anyone with access to the platform or by a predefined set of users, forwarding to a predefined set of contacts, for example via electronic mail, texting agent, Short Message Service (SMS) or Multimedia Message Service (MMS) message, or any other similar medium. Additionally or alternatively, the system may be configured to share the location of the system 600A on a social media network.

The location may be shared alone (e.g., as location tracking data, such as location tracking coordinates), or in conjunction with other information. The information may include, but is not limited to, a shared image, location information (e.g., a landmark, business, or other location in the vicinity of the shared location; it will be appreciated that the location may be shared with the location information, or the location information may be shared as the location), or any other suitable information.

The system 600A may be further configured to be used to report emergency information. For example, it may be configured to facilitate a user's inputting a report of an emergency and transmitting the emergency to the relevant emergency service (e.g., an emergency telephone number such as 911, 112, or 999, fire, police, or first aid services, an online emergency reporting service, etc.). It may further or alternatively be configured to automatically detect an emergency situation, for example by sensing disturbances to the vest (e.g., via the motion sensors), using image recognition of images captured via the camera 640, etc. The emergency information may include, but is not limited to, one or more of location, type of emergency, and images.

Further, the wearable may incorporate biometric sensors operable to monitor the vital signs or the wearer, Accordingly, the emergency information may include the biometric data. Additionally, or alternatively, biometric data may be displayed upon the display for use by those providing medical attention at the site of an emergency.

According to any one of the above examples, the controller may be configured, if it determines that a vehicle approaching from behind is too close or approaching too quickly, to activate one or more of the indicators 622 to display an appropriate warning to the vehicle.

The display may be further configured to display advertisement information. The information may be predetermined. According to some modifications, the controller may use GPS data to select and/or determine advertising information for display. For example, the signaling system 600A may be configured to display information relating to a business (e.g., a theater, restaurant, etc.) when the user is within a predetermined radius thereto. The signaling system may be further configured to display emergency information provided, e.g., by government agencies.

For example, in one embodiment, a display device may notify locals or those in specified areas of time and location sensitive information such as a sale or discount of food establishments that want to sell off or donate or sell at reduced prices any left over foods, or closing specials.

Third parties may be able to upload what they have, their location, which may be indicated by an icon or other indicator on devices worn by individuals in the local area. Such an application could specify any specific location which may be busier, and even in realtime, get updates for example but not limited to, traffic in a certain area, and a local pizzeria may flash a deal for pizza so people would be able to see options, specials in real time. This could be promoted via proprietor's own input, Artificial intelligence, Machine Learning or other updating. This would save food establishments from throwing away unused or unwanted food and help those in need or able to take advantage of specials. This can be used interface to interface. For example, two back packs can play or interact between themselves, either as a base or intermediary.

In addition to the wearable devices, the display may also comprise of roadside display boards known as signages used to communicate, to convey information designed to assist the receiver with decision-making based on the information provided. The display may be a digital screen installed in a vehicle for the passengers to visualize the information. For example, a digital screen installed on the back side of the front seat and visible to the passengers on the back seats. Moreover, the display may be LED shop display boards providing information of the current offers to the passing by locals.

The advertisements may be displayed on a display device considering the number of nearby people who can actually see the advertisement to increase their visuality and relevance. The system of the present information may adopt a number of mechanisms to determine the number of people present in the vicinity of the display for increasing the effectiveness of the advertisements being displayed. The display may also be digital displays of sports complexes or stadiums providing offers on the tickets on the current sports. The companies may also rent their building spaces for placing displays of third parties.

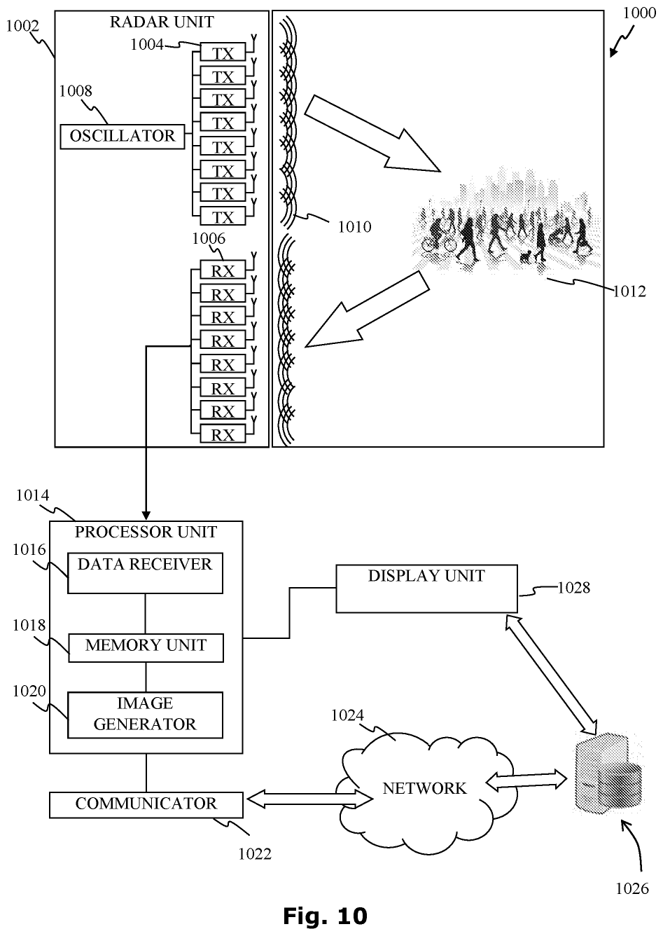

Reference is now made to FIG. 10 which provides a radar-based system 1000 to determine the number of people available in the vicinity of the advertisement display according to an aspect of the invention. The radar-based system 1000 may be included as a part of the wearable item 440 (FIG. 1). Further, the radar-based system 1000 may be installed on a roadside signage, a shop display board or any other display visible to a group of people. Alternatively, the radar-based system 1000 may be installed on a device separate from the wearable item 440 or public displays.

The system 1000 includes a radar unit 1002, a processor 1014, a display unit 1028 and a communicator 1022. The radar unit 1002 includes at least one transmitter antenna 1004 and at least one receiver antenna 1006 and an oscillator 1008. The transmitter 1004 is connected to the oscillator 1008 and configured to transmit electromagnetic radiation 1010 into a target region 1012. The receiver 1006 is configured to receive electromagnetic waves reflected by objects and people within the target region 1012.

The radar 1002 typically includes at least one array of radio frequency transmitter antennas 1004 and at least one array of radio frequency receiver antennas 1006. The radio frequency transmitter antennas 1004 are connected to an oscillator 1008 (radio frequency signal source) and are configured and operable to transmit electromagnetic waves 1010, such as microwave radiation or the like, towards the target region 1012. The radio frequency receiver antennas 1006 are configured to receive electromagnetic waves reflected back from objects within the target region 1012.

The target region 1012 may be a marketplace, a road, a cinema hall, a mall, a stadium, a sports complex, a business complex, a parking area, a hospital and any other public place.

The processor unit 1014 includes a data receiver 1016 configured to receive data from the radar unit 1002 and operable to execute an image data generation function to generate image data based upon the received data using an image generator 1020. The image generator 1020 may also be configured to identify the living beings from the non-living objects present in the target region 1012. Further, the image generator 1020 may also be configured to distinguish between the human beings from the animals present in the target region 1012 using any known face recognition technology. The image generator 1020 may further be configured to identify physical profiles of the human beings, like gender, age, physique, clothing pattern, spectacles, shoes, hairstyles, carried items, etc. The information generated by the image generator 1020 may be stored in a memory unit 1018.

The image generator 1020 may employ any of the known methods for identification of the human beings and their attributes. As a non-limiting example, the image generator 1020 may use a machine learning algorithm such as such as deep neural networks, deep belief networks, deep reinforcement learning, recurrent neural networks, convolutional neural networks and Transformers to analyze the radar data.

The communication module 1002 is configured and operable to communicate information generated by the image generator 1020 to third parties, such as a remote server 1026. The server 1026 may belong to an advertisement company which can assess the received information to decide for the appropriate timing of the advertisement to be displayed on the display unit 1028 based on the number of people in the vicinity of the display 1028. Since, the radar unit 1002 provides real-time information of the vicinity, the information may also be used to present targeted advertisement to the nearby people. For example, the advertisement may target the age group having maximum number of people in the marketplace. A gender specific advertisement may also be provided for increasing the sales of the nearby shops. The clothing pattern will also be useful for providing offers on the apparels.

In an alternative embodiment of the present invention, the communicator 1022 may communicate the information generated by the image generator 1020 to nearby shops, vendors and business establishments. The information may acquaint them of the features and attributes of the local crowd in the vicinity. The business establishments may quickly adopt their offers accordingly to increase the sales. For example, the offers may be modified to target the age group having maximum number of nearby people. The kids item shops may provide discounts on the items which can be displayed on a billboard near to a children's park when a large number of kids are identified in the park. Similarly, a discount on a cab service may be displayed on a digital board visible from a bus stop and having a large number waiting people.

In a particular embodiment, the radar unit 1002, the processor unit 1014, the communicator 1022 and the display unit 1028 may be a part of the same system, such as the wearable item 440, a roadside signage, a shop display board or any other display visible to a group of people. Alternatively, one or more of these components may be a part of a separate system. In an alternative embodiment, the processor unit 1014 may be deployed in the remote server 420. The data received from the radar unit 1002 may be processed in the remote server 420 to identify the crowd in the vicinity of the display unit 1028.

The radar system 1002 may be trained to identify the human beings and their attributes using Machine Learning (ML) algorithms. The system 1002 may employ any of the known ML algorithm as per the requirement. The algorithm can be a Supervised Learning algorithm which consists of a target/outcome variable (or dependent variable) which is to be predicted from a given set of predictors (independent variables). Exemplary Supervised Learning algorithms include Regression, Decision Tree, Random Forest, KNN, Logistic Regression etc. Alternatively, algorithm can be a Reinforcement Learning algorithm using which the machine is trained to make specific decisions. Exemplary Reinforcement Learning algorithm includes Markov Decision Process.

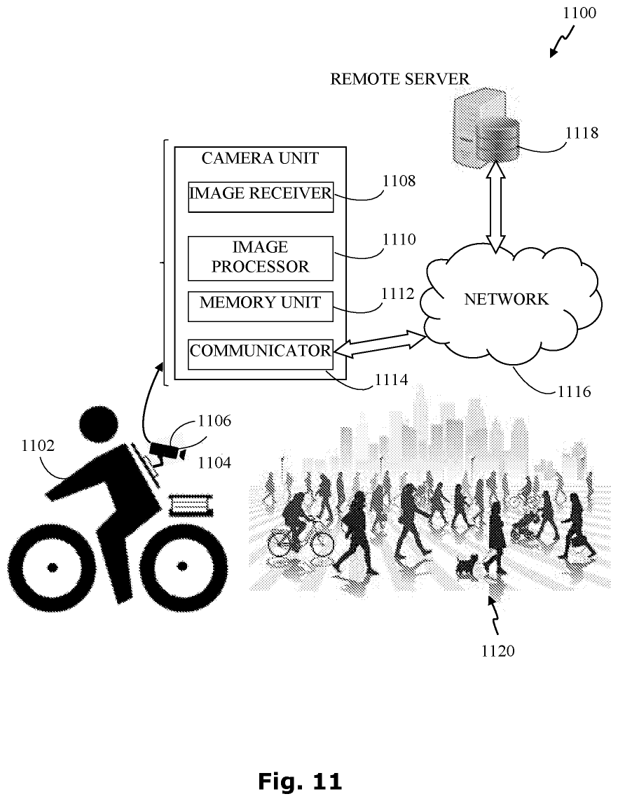

Reference is now made to FIG. 11 which provides a system 1100 employing an image capturing device 1104 installed on a wearable item 1104 by a user 1102 riding an open vehicle to determine the number of people available in the vicinity of the advertisement display according to another aspect of the invention. The image capturing device 1104 may alternatively be installed on a roadside signage, a shop display board or any other display visible to a group of people. Alternatively, the image capturing device 1104 may be installed on a device separate from the wearable item 1104 or public displays.

The image capturing device 1104 is configured to capture images in the vicinity of the wearable item 1104. The user 1102 wearing the wearable item 1104 may be stationary positioned in a target region 1120 to capture the images. For example, the user 1102 may be positioned stationary in a marketplace, on a road, near a cinema hall, a mall, a stadium, a sports complex, a business complex, a parking area, a hospital and any other public place. Alternatively, the user 1102 may be moving on a vehicle to capture images of different places of the target region 1120 through the image capturing device 1104.

The image capturing device 1104 may be a camera unit capturing still images or video images of the target region 1120. The camera unit 1104 may comprise an image receiver 1108 configured to receive images of the living beings and the non-living objects present in the target region 1120. An image processor 1110 is configured to receive the captured images and process it to identify the living beings from the non-living objects present in the target region 1120. Further, the image processor 1110 may also be configured to distinguish between the human beings from the animals present in the target region 1120 using any known face recognition technology. The image processor 1110 may further be configured to identify physical profiles of the human beings, like gender, age, physique, clothing pattern, spectacles, shoes, hairstyles, carried items, etc. as discussed above. The information generated by the image processor 1110 may be stored in a memory unit 1112.

A communicator unit 1114 is configured and operable to communicate information generated by the image processor 1110 to third parties, such as a remote server 1118 through the communication network 1116. The remote server 1118 may process the received information in a similar manner as discussed above for presenting advertisements on the display of the wearable item 1104.

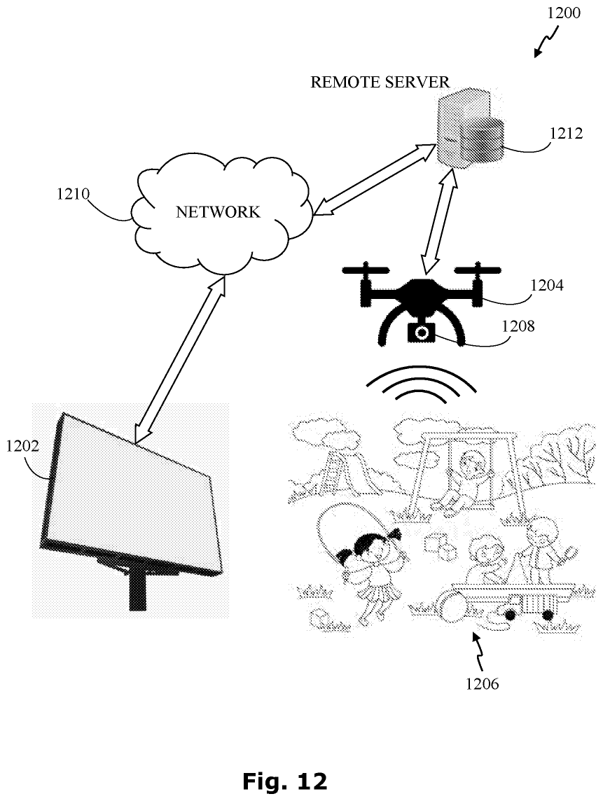

Reference is now made to FIG. 12 which provides a system 1200 employing an unmanned aerial vehicle (UAV) 1204, for example a drone, to capture images of a target region 1206 in the vicinity of a digital display 1202. The target region 1206 may be a children's park having swings and rides for kids of different age groups. The target region 1026 may also be a park providing playing fields as well as gym for elders.

The drone 1204 comprises a camera 1208 for capturing live images (still or moving images) of the target region 1206. The captured images may be sent to a remote server 1212 for further processing and identifying crowd in the target region 1206. Alternatively, the captured images may be processed within a processing system (not shown) of the drone 1204 and the processed information is sent to the remote server 1212 for targeted advertisements. The advertisements targeted to the human beings in the target region 1206 is sent from the remote server 1212 through a communication network 1210 to the display board 1202 for presenting and luring the human beings in the target region.

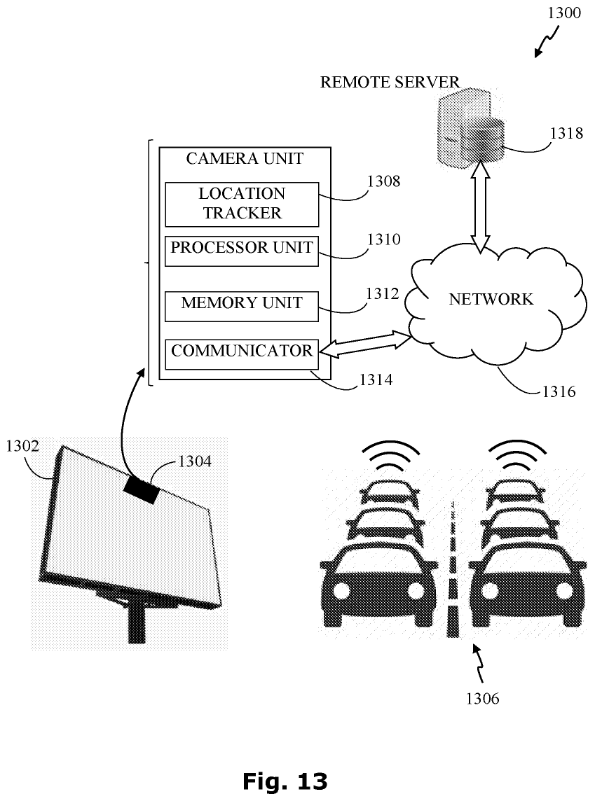

Reference is now made to FIG. 13 which provides an alternate system 1300 of the present invention with crowd identification through navigation system of the automotives 1306 on a road. A signage board 1302 on a roadside comprises a command signal generating unit 1304 operable to communicate with the navigation systems of the automotives 1306 on the road

The command signal generating unit 1304 may comprise a location tracker module 1308, configured to determine the number of automobiles on the road in real time by communicating with the satellite navigation system (such as the Global Positioning System (GPS) satellite network or the like). The location tracker module 1308 may determine its own location via GPS system and determine the current traffic status on the nearby road. The determined location information and the current traffic status is processed by a processing unit 1310 to determine the traffic crowd on the road. The processed information may be stored in a memory unit 1312. A communicator 1314 transmits the processed information to a remote server 1318, for example, a server of an advertising company to determine the optimum advertisement opportunities on the display board 1302. A heavy traffic provides a good opportunity for advertisements to be presented on the display board 1302.

In an alternative embodiment of the invention, the location tracker module 1308 may communicate with the external navigation system to identify the number of active mobile phones in the vicinity of the display board 1302. The advertisement companies may pre-set a criteria to present advertisements on the display board 1302 when the number of active mobile phones is above a predetermined threshold.

The crowd determined in the vicinity of the display through any of the methodology discussed above may be used to notify advertising companies, local vendors or business establishments an optimum timing for presenting advertisements on the display. The advertising companies, local vendors or business establishments can pre-set various criteria that can automatically trigger an advertising campaign. The criteria, for example, may be to trigger advertising campaign only when the crowd comprises female of specific age group. As another example, the advertisements of a toy selling company will be presented only when a predetermined number of kids are present in the vicinity of the display. Further, the companies or vendors can modify their promotional offers based on the determined crowd.

A driver, a cyclist, a pedestrian or any other nearby person having an application installed in their mobile phones of the product/service being advertised may automatically receive a notification of the promotional offers. As an example, a coupon code in form of a QR code may be triggered on the mobile phone of the nearby person to avail the offer. The coupon may be scaled up depending on the time of day or if a customer has not activated his app recently to entice them to frequent, by offering a special discount or coupon or other. Alternatively, the person may also log in to their installed applications to see if there any codes or coupons or special offers, discounts, being offered by the local establishments. Further, the offers being displayed can also be availed from the display boards or wearable display of the salesperson. For example, the display boards or wearable display may provide a QR code which the person may scan with his mobile phone to avail the offer. The person availing the offers may further be presented targeted ads aimed at his profile specifications and/or his current location.

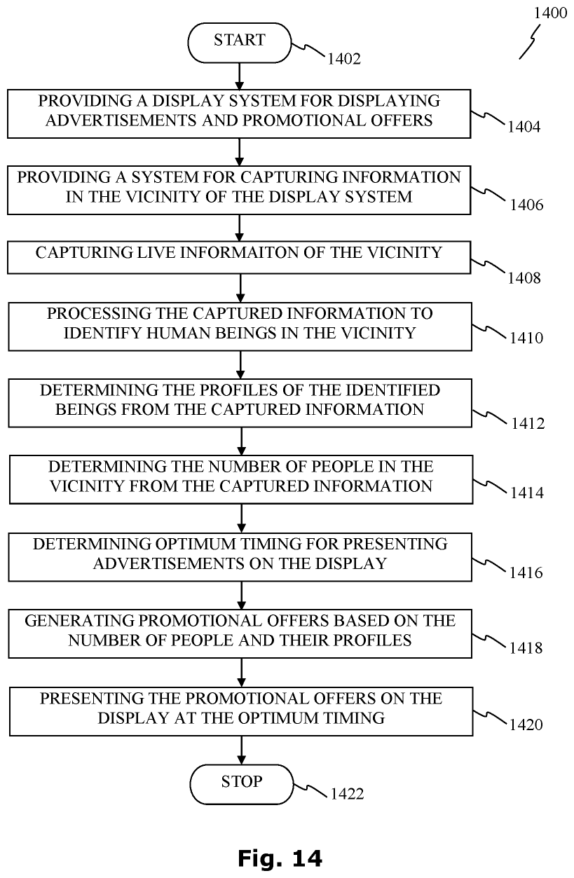

Reference is now made to FIG. 14 which provides a flowchart illustrating a method for presenting advertisements and promotional offers on a display. The process starts at step 1402 and a display system is provided at step 1404 for displaying advertisements and promotional offers. In addition to the wearable devices, the display may also comprise of roadside display boards known as signages used to communicate, to convey information designed to assist the receiver with decision-making based on the information provided. The display may be a digital screen installed in a vehicle for the passengers to visualize the information. For example, a digital screen installed on the back side of the front seat and visible to the passengers on the back seats. Moreover, the display may be LED shop display boards providing information of the current offers to the passing by locals.

At step 1406, a system is provided for capturing information in the vicinity of the display system. The system may comprise any device or a group of devices capable of screening a target area and capturing information thereof without limiting the scope of the invention. The system for capturing information may be the radar unit 1002 having transmitters and receivers for transmitting electromagnetic waves and receiving the signals reflected from the objects in the target area, respectively. The system may also be the image capturing device 1104 installed on the wearable item 1104 or on a roadside signage, a shop display board or any other display visible to a group of people. The image capturing device 1104 is configured to capture images (still images or videos) in the vicinity of the display. The system may further be the unmanned aerial vehicle (UAV) 1204, for example a drone, to capture images of a target region in the vicinity of the display. The system for capturing information may comprise the location tracker module 1308, configured to determine the number of automobiles on the road in real time by communicating with the satellite navigation system (such as the Global Positioning System (GPS) satellite network or the like). In an alternative embodiment of the invention, the location tracker module 1308 may communicate with the external navigation system to identify the number of active mobile phones in the vicinity of the display. One or more of these systems capture live images of the vicinity at step 1408.

At step 1410, the captured information is processed by a processing unit to identify the living beings from the non-living objects present in the target region. Further, the processing unit may also be configured to distinguish between the human beings from the animals present in the target region using any known face recognition technology. At step 1412, the image processing unit may further be configured to identify physical profiles of the human beings, like gender, age, physique, clothing pattern, spectacles, shoes, hairstyles, carried items, etc.

At step 1414, the processed information is used to determine the number of people in the vicinity of the display. The information may be processed by the processing unit installed in the display system. Alternatively, the information may be processed by a remote server of an advertising company to determine the crowd in the vicinity of the display system. At step 1416, the remote server determines the optimum time for presenting advertisements on the display based on the determined crowd. Further, since real-time information of the vicinity is captured, the information may also be used to present targeted advertisement to the nearby people. At step 1418, the promotional offers are generated by the companies, local vendors and business establishments based on the number of people in the vicinity and their profiles. At step 1420, the advertisements and promotional offers are presented on the display at the optimum timing. The process stops at step 1422.

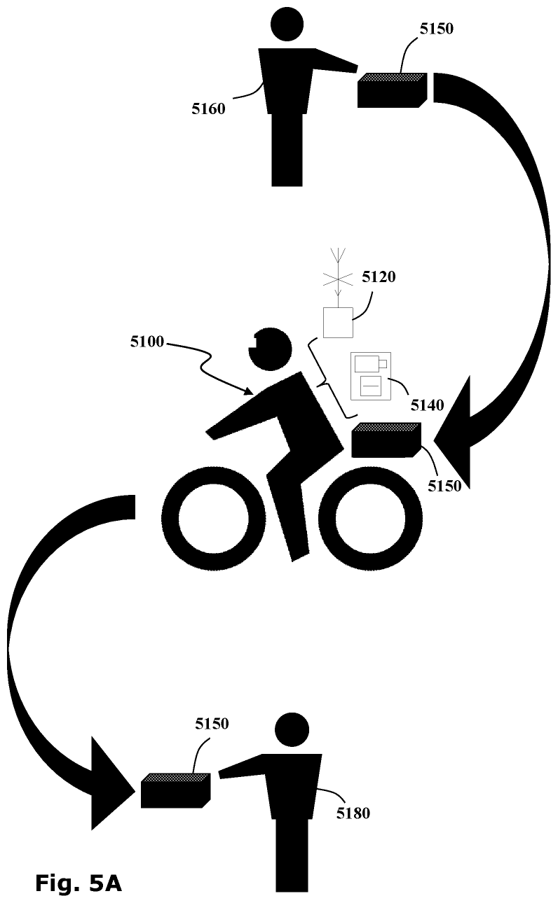

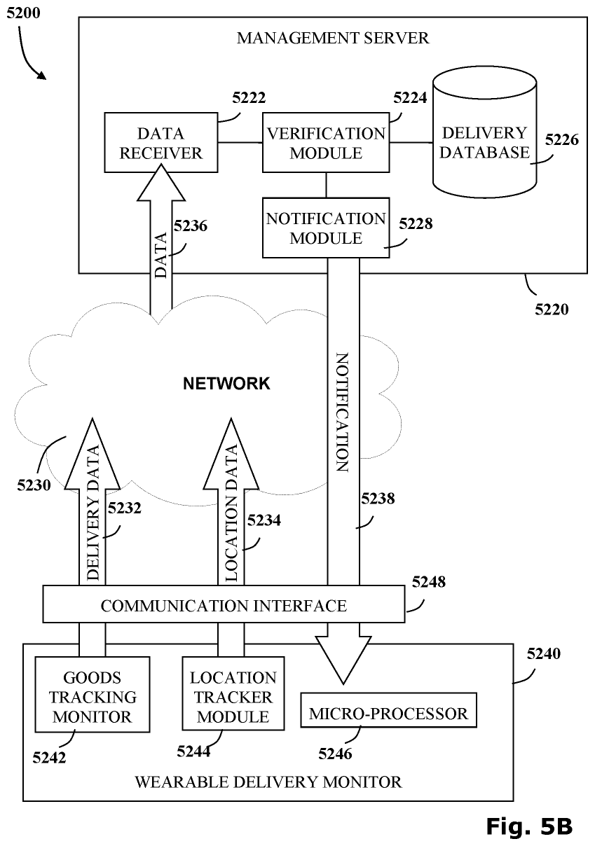

Referring now to FIG. 5A, a delivery agent wearing a wearable delivery monitor 5100 may deliver a goods package 5150 from a first party 5160 to a second party 5180. The wearable delivery monitor 5100 includes a location tracker 5120 and a goods tracking monitor 5140. The delivery monitor 5100 may be used for recording the transfer of goods at either or both of the collection point and the delivery point.

It is noted that a monitor 5140, such as a video camera or the like, may be integrated into an item of clothing. The item of clothing, such as a jacket, coat, helmet, hat spectacles, pants, bag, backpack, watch, shoe or the like as well as combinations thereof may be worn by a delivery agent. The monitor 5140 may further be in communication with a location tracker 5120 such as included in the platform described in U.S. patent application Ser. No. 15/113,831 and U.S. Pat. No. 10,133,548 which are incorporated herein in their entirety.

Accordingly, the wearable item 5100 may locate the delivery agent and the monitor 5120 and may be automatically triggered to record data upon collection and delivery of the goods 5150 for example when the delivery worker arrives at the delivery address. A camera may record the whole process of delivery or collection as a video which may be used to confirm delivery or collection and to indicate the location of the delivery if required.

Where appropriate the recorded data may be processed and sent to the delivery company and/or the customer as required. In particular where nobody is available to receive the delivered item, automatically captured video data may be used to provide evidence of such.

Referring now to FIG. 5B, a delivery monitoring system 5200 may further include a delivery monitor 5240 integrated into a wearable item and a management server 5220 connected via a communication channel such as a computer network 5230.

The wearable delivery monitoring system 5240 includes a goods tracking monitor 5242, a location tracker 5244 and a micro-processor 5246. The system 5240 is in communication with the management system via a communication interface 5248.

The location tracker module 5244, such as a satellite navigation unit, a cellular network or the like, is operable to track the current location of the wearable item 5240. The location tracker module 5244 is configured to provide location based data which is communicated to the management server.

The goods tracking monitor 5242 is operable to record and confirm delivery of goods being delivered. The goods tracking monitor 5242 is configured to provide delivery data. For example, the goods tracking monitor 5242 may comprise a scanner or a camera or the like.

The micro-processor 5246 is operable to coordinate and control the delivery monitor 5240.

The management server 5220 includes a data receiver 5222, a verification module 224 in communication with a delivery database 5226 and a notification module 5228.

The delivery database 5226 is configured and operable to store data pertaining to required deliveries.

The data receiver 5222 is configured and operable to receive goods data 5236 including the location based data 5234 from the location tracker 5244 and delivery data 5232 from the goods tracking monitor 5242.

The verification module 5224 is configured and operable to compare data 5236 received by the data receiver 5222 with data stored in the delivery database 5226. Optionally, the delivery management server 5220 further comprises a notification module 5228 operable to communicate notifications 5228 to the delivery agent via the delivery monitor 5240.

Various features of the system may enable more efficient and secure transfer of goods by monitoring both the collection and delivery of those goods. For example, the camera may be operable to identify or scan a code, such as an alphanumeric code, a bar code, a QR code or the like, which may be included with the item to be delivered, possibly using an integrated image recognition mechanism. Accordingly, the monitor may use the code to confirm that the corresponding items are delivered to the correct delivery address or receiver.

A communication manager may be operable to ensure that data, such as image data, location data, identification data and combinations thereof, may be communicated via a communication agent in real time to the delivery company which may automatically or manually confirm delivery details with the details stored on a delivery management server or database. The system may send a confirmation notification to the delivery agent to continue to the next delivery address. Additionally or alternatively if the recorded monitor data do not match the stored details, a corrective instruction or query may be sent to the delivery agent. Where required, a delivery worker may be prompted to contact a delivery manager for clarification before proceeding to the next delivery.

In other aspects the disclosure teaches a method for efficient and safe dispensing and delivery of prescription drugs. A pharmacy or drug dispenser may send prescription drugs using a delivery agent, such as an external delivery service provider.

Using a delivery monitoring system such as described herein, the delivery may be confirmed to be to the correct destination and even to the correct individual to be receiving the drugs.

A delivery agent collecting the drugs from a pharmaceutical supplier may perform a collection protocol including video comparison between the collected package and the original prescription issued by a medical practitioner to a patient according to local regulations. Such a confirmation mechanism may allow the prescription medicines to be validated and confirmed upon the point of collection such that any discrepancies or inaccuracies may be identified in real time at the point of collection. Where required, a request for clarification or query may be sent to the medical practitioner, who may authorize the amended instructions.

The wearable display may be incorporated into a personal security platform operable to provide automatic security measures and help if facing hostility, aggression, harassment, or any other emergency situation, mostly while in an outdoor activity such as biking, jogging, walking, usage of any open vehicle and the like. The platform comprises a wearable item worn by a user comprising a micro-processor (not shown) and a command signal generating unit configured to generate at least one command signal communicated via the communication network using the communication interface for controlling at least one protecting agent. The command signal generating unit may be further operable to communicate command signals to a remote server via the communication network comprising relevant data messages.

It is noted that the wearable item may be a device, a token and the like attached to the user garment.

It is also noted that the personal security platform is configured to be activated automatically upon identifying an alerting condition, or manually by pressing a button or by pulling a cord, for example, or may be voice activated.

It is specifically noted that in addition, the personal security platform is operable to provide various technical features, as described hereinafter. The platform, using wearable technology, may include controllable high visibility displays (rear-facing, back-facing for example), various image capturing devices operable to record the journey/ride/walk, tracking the route using location tracking devices such as satellite navigation systems, provide social connectivity to share and communicate with friends and other riders, for example, emergency monitoring services to support any unexpected conditions and provide help services.

Additionally, the personal security platform is operable to communicate a signal message to the drone to trigger a sound broadcasting function in the drone so that, in case of emergency, the drone can activate a voice from loudspeakers to scare off threats.

It is noted that, accordingly, the wearable technology application may be provided with high visibility turn signals, cameras to record a journey as well as connectivity to track a route, friends and biometrics. Selected features of the system may include: LED Turn Signals and Brake Lights; satellite navigation, location tracking and mapping to assist navigation and to track other riders; social connectivity to allow connecting with friends and other riders; image capturing devices to record a journey (photos and videos); and further, when necessary provide emergency monitoring service.

The platform, as such may include: various type of image capturing devices and cameras (front, back, side), microphone and call buttons, LED turning signals, brake lights, reflective material, location tracker and navigation system, social and emergency connectivity via an associated software application running on a mobile communication device.

Accordingly, the smart LED indicator may include: High Visibility turn signals; brake lights and running lights; motion control sensors; auto-activated brake lights; satellite navigational mapping may automatically activate turn signals which may provide various safety and security measures of high visibility and safety; hands free activation possibly via voice activated controls using an integrated microphone; broadcast current location; and emergency mode may be triggered by a motion controlled accident sensor, for example, and may automatically engage hazard lights, camera, emergency calls.

Additionally, the integration of a front and back cameras may allow features including: recording the road, monitoring around, hands free activation, high quality image recording and well positioned point of view.

Furthermore, an emergency alert feature may be triggered by a push button or sensor input for example indicating sudden stop/falling.

An automatic notification interface may be provided for communication with autonomous vehicles. It is noted that such an interface may make the user visible to self-driving automobiles and the like.

A live video feed function may be triggered in the drone by key events (optionally, based upon signal commands received from the user) such as an impact, a fall or an attack. Accordingly, the drone can send a live video feed to a desired address, possibly to a particular telephone number or e mail address.

The personal security platform may provide a list of benefits, such as capturing adventures; sharing with friends online; storing captured images in the cloud; documenting emergency and dangerous situations, including attacks, harassments and the like; using a motion controlled accident sensor to automatically engages hazard lights; using cameras and emergency calls.

It is a particular feature of embodiments that a voice sensitive microphone may be incorporated into the wearable system. The features of the microphone may include: voice activated and on/off call button; hands free activation; Bluetooth connectivity with smartphones.

Furthermore, executing an appropriate software application may provide additional benefits including: calling for emergency help activated by voice′ including provide full functionality activation by voice; communicating with friends and narrating the journey.

The system may feature satellite navigation, mapping and tracking, providing various benefits including: people tracking allowing one to keep their children safe, knowing always their location; providing self-tracking knowledge (know where you are and where you are going to); finding best routes and point of interest; finding ride/jogging times and distances; tracking friend in real time; and archiving routes, speed and distance data.

Accordingly particular benefits supported by the personal security platform include: satellite navigation mapping via smartphone application; hands free voice activation; saving favorite destinations and routes; tracking other riders; and tracking of children by their parents.

Additionally, social connectivity features of the platform may include: real-time social connectivity; hands free activation; voice navigation; and tapping into the social community.

It will be appreciated that these features provide still further benefits such as: connecting with friends online all along during a journey; sharing of rides with photos, video, voice recordings, tipping of great rides and destinations; and connecting directly to social network such as Facebook and favorites social media applications.

The platform may also offer twenty-four hour emergency monitoring service features, including: emergency call services; tracking services of the ride; motion control sensor auto-activated in an emergency mode to engage automatically hazard lights, brakes, cameras and emergency calls and alarms; providing pre-programmed emergency call dials such as 911 and the like.

The Associated software application may provide still further features, including: simple, smart, intuitive hands free activation of all features; supporting of watches of Apple IOS, Android and other smart watches; Bluetooth connectivity; free download for all updates; providing premium features with subscription; enabling GPS mapping, tracking and social connectivity; health reporting with tracking and archiving; providing routes, speeds and distances; saving and sharing of favorite routes; providing photos, videos, tipping of destinations; social connectivity and community.

It is noted that a children notification feature may be supported for example while a student is with a school bus. The driver may receive indications that a passenger (a student) is waiting at a specific bus stop.

Additionally, the monitoring option may be configurable by a parent/supervisor to a specific set of parameters. If the child/user using the software application, the parent or the supervisor may configure the parameters such that if changed or if the child strays outside this set of parameters, a notification will be transmitted to increase safety and security.

Furthermore, if the child/user inputs into the software application a destination setting, the Parent/Supervisor may be notified of the chosen destination

It is noted that in some embodiments a variety of further functions and systems may be enabled, including: a “Visible Me” function may allow the following:
A third party location tracking agents may connect with the software application so they will be able to notify a driver that a rider is approaching or near.
At the same time the biker may get a notification that a car is approaching
These features may be activated while a car is going above a certain threshold speed, say 20 MPH or more. The speed feature may be disabled in specific area such as city center, where bike riders are assumed to be close to city traffic, thus alerting and notifications are also disabled.
When a driver is signaling with his indicator, right or left, and a biker is behind, the software application in conjunction with the location tracking agent of the car, may notify the car that a biker is behind.
It is further noted that a microprocessor may be incorporated into the wearable item and will process all relevant data and communication, the microphone on the wearable item and the earpiece will continue to communicate if the officer loses his phone or walkie-talkie for example, a police officer, firefighter, correction officer and other security guards, if they were to fall or some unnatural movement, (such as falling from a bike) which will be sensed and notification will be sent to the pre-programmed number or the back office or headquarters of the monitoring station.
While wearing the wearable item, with the microprocessor, if a police officer un-clips his gun from the holster, it will immediately notify the back office or headquarters of the monitoring station.
The back office will be able to remotely turn on the wearable item camera and/or the microphone and other communications on the wearable item.

Moreover, the platform may be configured such that there is an emergency button on the wearable item itself that can be pushed to call for help.

Additionally, one should appreciate that:
(A) In known historically dangerous intersections and roads, the LED lights, will automatically light up to ensure visibility.
(B) In known historically dangerous intersections and roads, the camera will automatically turn on for safety purposes.
(C) A drone will be able to follow the user automatically, possibly via the app
(D) The app will be configurable to automatically notify a school bus driver, of a child's bus stop, that the child was picked up at the stop and dropped off at the school. This can be via the software application, if a child does not have a smartphone, there will be a separate device with the vest.

The personal security platform may be operable in a monitoring mode reading input from the environment automatically via the various platform component such as location tracker module, motion sensors image capturing device and the like. The platform may be in communication with various protecting agents which may be configured to be in a listening mode, waiting for an activation signal from the personal security platform either for a continuous tracking of the user or activation of a specific action.

If a signal command is received such an activation signal or location update, the protecting agent is configured to respond accordingly and further may provide a response signal of confirmation.

When in monitoring mode, the personal security platform may be configured to periodically transfer location command signals to allow for tracking of the user by the UAV, for example.

As detailed below, various command signals may be used with the platform. The command signals may be generated by a signal command generating unit of the platform in response to automatic analysis of the monitored input or in response to actual commands of the user initiated manually (pressing a button, for example) or by voice commands.

Reference is now made to FIG. 6A, there is provided a system architecture of the personal security platform, which is generally indicated at 200, the architecture presents the various system components of the personal security platform. The system architecture 200 comprises a wearable item 210 operable to control at least one protecting agent such as a first protecting agent 212, a second protecting agent 214 and a third protecting agent 216.

It is noted that the protecting agents 212, 214 and 216 are presented as an example only and is intended to specify one or more protecting agents.

The wearable item 210 is configured to be worn by the user or attached to his garment, and comprises a micro-processor 230, a command signal generating unit 240 and a communication interface 250.

The micro-processor 230 is configured to execute a software application module comprising a set of component modules such as an image module 232 configured to manage a protecting agent of an image capturing device 272, a sensor module 234 configured to manage a protecting agent of at least one motion sensor 274, a display module 236 configured to manage a protecting agent of at least one display.

The protecting agent of the display 276 may include a rear-facing display attached to the back of the user or a front-facing display attached to the user at the front or both.

The protecting agent of the motion sensor 274 is configured to determine at least one motion parameter associated with the user and may be one or more of an accelerometer, a tilt sensor and a proximity sensor.

The protecting agent of the image capturing device 272 may include at least one camera that may be selected from a group of cameras consisting of a front camera, a back camera, a side camera and combinations thereof.

The command signal generating unit 240 is configured to generate at least one command signal to allow communicating via said communication interface for controlling at least one protecting agent such as a protecting agent 212, a protecting agent 214 and a protecting agent 216 (using communication channels “A”, “B” and C” respectively).

It is noted that the communication interface 250 is further operable to enable communication with at least one remote server.

The personal platform further comprises a location tracker module 260 for tracking a location of the user, and the location tracker module is configured to provide location based data.

Optionally, the wearable item 220 comprises the location tracker module 260. Additionally, the wearable item 220 is configured to retrieve map data from an external source, based on data from the location tracking module 260. Optionally, the location tracker module 260 comprises a satellite navigation system. As appropriate, the location tracker module 260 is configured to communicate with an external satellite navigation system.

It is noted that a particular feature of the current disclosure is that at least one of the personal protecting agent (212, 214, 216) comprises an unmanned aerial vehicle (UAV), and that the software application module is configured to communicate with at least one of the unmanned aerial vehicle (UAV) such that the software application module controls the UAV.

It is noted that the protecting agent may further be selected from one or more of: a rear-facing display, front-facing display, at least one motion sensor and at least image capturing device.

Additionally, the emergency feature may be operable by voice or activated loudly via a speaker to announce, for example, “YOU HAVE BEEN RECORDED” so as to deter a threat. Optionally, the emergency feature may be initiated by a user activated push button or the like.

Reference is now made to FIG. 6B, there is provided an activation mechanism of the personal security platform, which is generally indicated at 300, the activation mechanism 300 configured to provide automatic activation methods, manual activation methods and voice activation. The activation mechanism 300 comprises a command signal generating unit 310 operable to receive input from various components via an input interface 312 and further generate appropriate output signal commands to operate the security platform accordingly.

The personal security platform is operable to receive input from various platform components and agents such as the Location Tracker (FIG. 6B, item 260), image Capturing Devices (FIG. 6B, item 272), Motions Sensors (FIG. 6B, item 274), displays (FIG. 6B, item 276) and the like in order to generate the necessary automatic commands. Additionally or alternatively, the personal security platform is further operable to drive various platform functions manually or read voice enabled commands to generate the desired signal commands. Thus, the command signal generating unit 310 is configured to read manual input from manual components such as a push button 320 (via input “A”), a button 330 (via input “B”) or similar other manual components such as pull cords (not shown) and the like. The command signal generating unit 310 may be further configured to read vocal commands via a microphone 340 (via input “C”) associated with the personal security platform and activate the platform as appropriate. Optionally, the voice activation of the security platform may include a pre-configured set of voice commands.

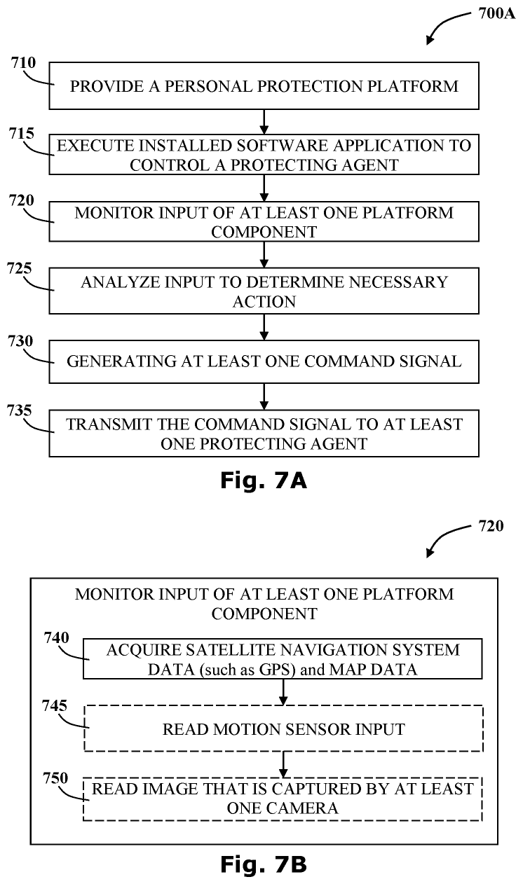

As illustrated in FIG. 7A, a method 700A may be provided, whereby the personal security platform 700A is operable to control at least one protecting agent.

In step 710 of the method 700A, a personal security platform for providing security measures to a user is provided, such as described hereinabove.

In step 715, the personal security platform 200 is configured execute the software application installed on the micro-processor 230 (FIG. 2) to provide the logic for controlling at least one protecting agent, thus providing the required safety and security measures to the user.

In step 720, the platform 200 monitors input received from the various platform components, relating to the current scenery thereof, from a location tracker module (FIG. 2, item 260), image module (FIG. 2, item 232) associated with captured images of at least one camera, sensor module (FIG. 2, item 234) associated with motion parameters. According to some examples, the location tracker module is integrated with the personal security platform 200. According to other examples, the location tracker module is external to the security platform 200 (such as a smartphone or a standalone location tracker module), and the platform is configured to communicate with it, inter alia to receive GPS data.

In step 725, the security platform 200 analyzes the input acquired as described in step 720 and determines the required action based on the location information provided by the location tracker, the sensor parameters and image and video data.

In step 730, the security platform 200 generates the necessary signal commands to trigger the required action. The signal commands may be generated by the signal command generating unit (FIG. 2, item 240). Alternatively, the signal commands may be generated by the micro-processor (FIG. 2, item 230).

In step 735, the security platform 200 transmits the generated signal command (as described in previous steps) to the at least one protecting agent (FIG. 2, items 212, 214, 216) or specifically to one UAV such as presented in FIG. 1A (items 120A, 120B) to execute desired control action.

As illustrated in FIG. 7B, a method 720 may be provided whereby the personal security platform 200 is operable to monitor input of at least one platform component, as indicated in FIG. 1. The platform 200 may monitor input relating to the current scenery thereof, from a location tracker module (FIG. 2, item 260), image module (FIG. 2, item 232) associated with captured images of at least one camera and sensor module (FIG. 2, item 234) associated with motion parameters.

In step 740 of the method 720, a personal security platform may acquire satellite navigation system data (such as GPS) and map data.

In step 745 of the method 720, the personal security platform 200 is operable to read input from at least one motion sensor; and In step 750 of method 720, the personal security platform 200 is operable to read at least one captured image from at least one camera.

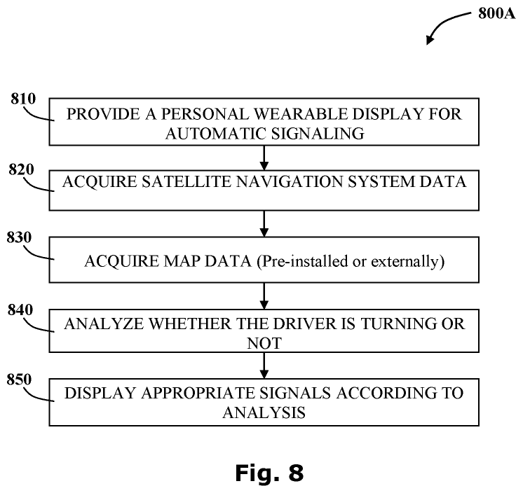

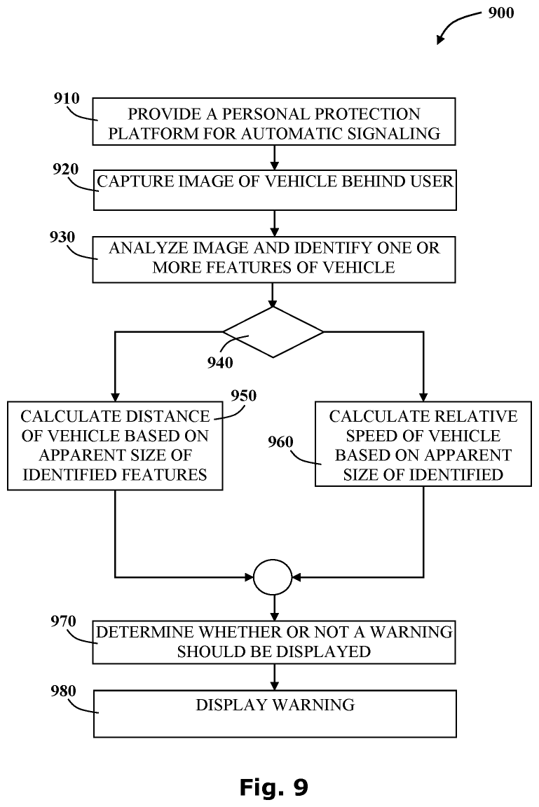

As illustrated in FIG. 8, a method 800A may be provided, whereby the platform 600A indicates a turn signal on its display 620.

In step 810 of the method 800A, a personal security platform for automatic signaling 600A is provided, such as described above with reference to FIGS. 6A and 6B. In particular, the platform 600A may be configured to acquire satellite navigation system and location data, and may comprise a display 620 with indicators 622, a controller, and one or more motion sensors, such as one or more accelerometers, one or more tilt sensors, etc.

In step 820, the platform 600A acquires data, relating to the current location thereof, from a location tracker module. According to some examples, the location tracker module is integrated with the platform 600A. According to other examples, the location tracker module is external to the platform 600A (such as a smartphone or a standalone location tracker module), and the platform is configured to communicate with it, inter alia to receive GPS data.

In step 830, the platform 600A acquires map data corresponding to the GPS data acquired in step 820. According to some examples, the platform 600A is preloaded with the map data. According to other examples, the system is configured to acquire the map data from an external source (such as a smartphone or by connecting directly to an information server, e.g., via the internet), e.g., on demand based on the GPS data.

In step 840, the platform 600A determines, based on information provided by the motion sensors thereof, whether or not the vehicle being driven by the user is turning.

As In step 850, the controller determines, based on the location information provided by the location tracker, the map data, and the information provided by the motion sensors, whether or not a turn signal should be displayed. For example, if the motion sensors indicate a turn, but the GPS and map data indicate that the user is following the topography of the road, the controller may determine that no turn signal should be displayed. If the motion sensors indicate no turn, but the GPS and map data indicate that the user is entering an exit ramp, the controller may determine that a turn signal should be displayed.

In step 860, if the controller in step 850 determined that a turn signal should be displayed, indicators 622 of the platform 600A are activated to display the appropriate signal.

Reference is now made to FIG. 9, another method 900 may be provided, whereby the platform 600A indicates a warning to vehicles therebehind on its display 620.

In step 910 of the method 900, a platform 600A is provided, such as described above with reference to FIGS. 6A and 6B. In particular, the platform 600A may be provided with a controller, a display 620 with indicators 622, and a camera 640.

In step 920, the camera 640 captures an image of a vehicle behind the user.

In step 930, the controller analyzes the image captured by the camera, and identifies one or more features of the vehicle therebehind.

In decision step 940, the controller chooses to determine whether to assess the distance (in step 950 below) or speed (in step 960 below) of a vehicle approaching therebehind.

In step 950, the controller compares the identified features, and calculates its distance based on the apparent size thereof based on the captured image, and preloaded information relating to its actual size. For example, the controller may be preloaded with information relating to the actual size of a license plate. Information relating to the apparent size of the portion of the captured image corresponding to the license plate (such as the number of vertical and/or horizontal pixels thereof, and camera information) is used to calculate the distance the license plate would be to produce such an image.

In step 960, the controller compares the relative size of one or more of the same identified features in different frames captured by the camera 640. By comparing the change in size of these features, and taking into account the elapsed time between the captured frames, the controller calculates if the vehicle approaching from behind is accelerating, or maintaining its speed (e.g., when it should be slowing down), etc.

It will be appreciated that the method 900 may be provided without one of steps 950 and 960 (and without the decision step 940), and/or with steps 950 and 960 be performed in parallel, without departing from the scope of the presently disclosed subject matter, mutatis mutandis.

In step 970, the controller determines, based on the calculations performed in either or both of steps 950 and 960, whether a warning to vehicles therebehind should be displayed.

In step 980, if the controller in step 970 determined that a warning should be displayed, indicators 622 of the platform 600A are activated to display the appropriate signal.

Those skilled in the art to which this invention pertains will readily appreciate that numerous changes, variations and modifications can be made without departing from the scope of the invention mutatis mutandis.

Technical and scientific terms used herein should have the same meaning as commonly understood by one of ordinary skill in the art to which the disclosure pertains. Nevertheless, it is expected that during the life of a patent maturing from this application many relevant systems and methods will be developed. Accordingly, the scope of the terms such as computing unit, network, display, memory, server and the like are intended to include all such new technologies a priori.

As used herein the term “about” refers to at least ±10 %.

The terms “comprises”, “comprising”, “includes”, “including”, “having” and their conjugates mean “including but not limited to” and indicate that the components listed are included, but not generally to the exclusion of other components. Such terms encompass the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” may include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments or to exclude the incorporation of features from other embodiments.

The word “optionally” is used herein to mean “is provided in some embodiments and not provided in other embodiments”. Any particular embodiment of the disclosure may include a plurality of “optional” features unless such features conflict.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween. It should be understood, therefore, that the description in range format is merely for convenience and brevity and should not be construed as an inflexible limitation on the scope of the disclosure. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6 as well as non-integral intermediate values. This applies regardless of the breadth of the range.

It is appreciated that certain features of the invention, which are, for clarity, described in the context of separate embodiments, may also be provided in combination in a single embodiment. Conversely, various features of the disclosure, which are, for brevity, described in the context of a single embodiment, may also be provided separately or in any suitable sub-combination or as suitable in any other described embodiment of the disclosure. Certain features described in the context of various embodiments are not to be considered essential features of those embodiments, unless the embodiment is inoperative without those elements.

Although the invention has been described in conjunction with specific embodiments thereof, it is evident that other alternatives, modifications, variations and equivalents will be apparent to those skilled in the art. Accordingly, it is intended to embrace all such alternatives, modifications, variations and equivalents that fall within the spirit of the invention and the broad scope of the appended claims.

Additionally, the various embodiments set forth hereinabove are described in term of exemplary block diagrams, flow charts and other illustrations. As will be apparent to those of ordinary skill in the art, the illustrated embodiments and their various alternatives may be implemented without confinement to the illustrated examples. For example, a block diagram and the accompanying description should not be construed as mandating a particular architecture, layout or configuration.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a computer-readable medium such as a storage medium. Processors may perform the necessary tasks.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present disclosure. To the extent that section headings are used, they should not be construed as necessarily limiting.

The scope of the disclosed subject matter is defined by the appended claims and includes both combinations and sub combinations of the various features described hereinabove as well as variations and modifications thereof, which would occur to persons skilled in the art upon reading the foregoing description.

1. A system for automatically presenting information visually to third parties, the system comprising:
a visual display configured to display promotional offers to the third parties;
an information capturing system configured to capture live information in a vicinity area of the visual display;
a processing unit configured to process the captured information and determine the number of people in the vicinity area of the visual display;
a communicator configured to communicate the processed information; and
a server unit configured to receive the processed information through the communicator and generate promotional offers based on the determined number of people;
characterized in that the processing unit determines an optimum timing for presenting the promotional offers on the visual display based on the determined number of people in the vicinity of the visual display, and
the visual display presents the promotional offers to the third parties at the optimum timing to increase effectiveness of the promotional offers.

2. The system of claim 1, wherein the visual display comprises one or more of a wearable visual communications unit, an electronic display board, a digital screen installed in a vehicle, a digital shop display board or a public display device.

3. (canceled)

4. The system of claim 1, wherein the information capturing system comprises a radar-based system comprising an array of transmitters and receivers for transmitting electromagnetic waves towards a target region in the vicinity area and receiving the signals reflected from objects in the target area, respectively.

5-6. (canceled)

7. The system of claim 1, wherein the information capturing system comprises an unmanned aerial vehicle (UAV) configured to capture images in the vicinity of the visual display.

8. The system of claim 1, wherein the information capturing system comprises a location tracker module configured to determine the number of automobiles on a road in the vicinity of the visual display in real time by communicating with a satellite navigation system.

9. The system of claim 1, wherein the information capturing system comprises a location tracker module configured to communicate with an external navigation system to identify the number of active mobile phones in the vicinity of the visual display.

10. The system of claim 1, wherein the information capturing system is part of the visual display.

11-14. (canceled)

15. The system of claim 1, wherein the server unit is further configured to:
a. receive live information from the information capturing system;
b. process the captured information and determine the number of people in the vicinity area of the visual display; and
c. determine an optimum timing for presenting the promotional offers on the visual display based on the determined number of people in the vicinity of the visual display.

16. The system of claim 1, wherein the server unit is a remote unit of an advertising company, a local shop or a business establishment.

17. The system of claim 12, wherein the server unit is further configured to generate targeted offers based on the physical characteristics of the human beings in the vicinity area.

18. The system of claim 1, wherein the visual display is further configured to provide a means for availing the promotional offers.

19. The system of claim 18, wherein the means for availing the promotional offers comprises presenting on the visual display one or more of a coupon code, a bar code, a QR code.

20. A method for automatically presenting information visually to third parties, the method comprising:
providing a visual display configured to display promotional offers to the third parties;
capturing live information in a vicinity area of the visual display using an information capturing system;
processing the captured information and determining the number of people in the vicinity area of the visual display;
determining an optimum timing for presenting the promotional offers on the visual display based on the determined number of people in the vicinity of the visual display;
generating promotional offers based on the determined number of people; and
presenting the promotional offers on the visual display at the optimum timing to increase effectiveness of the promotional offers.

21. The method of claim 20, wherein the capturing live information comprises capturing through a radar-based system comprising an array of transmitters and receivers for transmitting electromagnetic waves towards a target region in the vicinity area and receiving the signals reflected from objects in the target area, respectively.

22-23. (canceled)

24. The method of claim 20, wherein the capturing live information comprises capturing through an unmanned aerial vehicle (UAV) configured to capture images in the vicinity of the visual display.

25. The method of claim 20, wherein the capturing live information comprises capturing through a location tracker module configured to determine the number of automobiles on a road in the vicinity of the visual display in real time by communicating with a satellite navigation system.

26. The method of claim 20, wherein the capturing live information comprises capturing through a location tracker module configured to communicate with an external navigation system to identify the number of active mobile phones in the vicinity of the visual display.

27. The method of claim 20, wherein processing the captured information further comprises:
a. identifying living beings and non-living beings in the vicinity area;
b. identifying human beings and non-human beings in the vicinity area; and
c. identifying physical characteristics of the human beings in the vicinity area.

28. (canceled)

29. The method of claim 27, wherein generating promotional offers further comprises generating targeted offers based on the physical characteristics of the human beings in the vicinity area.

30. The method of claim 20 further comprising providing a means for availing the promotional offers on the visual display.
